(19) United States
(12) Patent Application Publication
(10) Pub. No.: US 2024/0428068 A1
(43) Pub. Date: Dec. 26, 2024

(54) SYSTEMS AND METHODS FOR A NEURAL NETWORK BASED SHOPPING AGENT BOT

(71) Applicant: Salesforce, Inc., San Francisco, CA (US)

(72) Inventors: Lidiya Murakhovs'ka, Ontario (CA); Philippe Laban, Palo Alto, CA (US); Tian Xie, Palo Alto, CA (US); Chien-Sheng (Jason) Wu, Palo Alto, CA (US)

(21) Appl. No.: 18/393,019

(22) Filed: Dec. 21, 2023

Related U.S. Application Data
(60) Provisional application No. 63/510,085, filed on Jun. 23, 2023.

(51) Int. Cl. G06N 3/08; G06Q 30/0601

(52) U.S. Cl. CPC G06N 3/08; G06Q 30/0631

(57) ABSTRACT

In view of the need for a conversational recommender system (CRS) in guiding purchasing processes of complex items, embodiments described herein provide a CRS system that creates a realistic purchase scenario and agent evaluation for fulfilling the recommendation objective. Specifically, the CRS system utilizes existing buying guides as a knowledge source for the recommendation model.

### CROSS REFERENCE(S)

The instant application is nonprovisional of and claims priority to U.S. provisional application No. 63/510,085, filed Jun. 23, 2023, which is hereby expressly incorporated by reference herein in its entirety.

### TECHNICAL FIELD

The embodiments relate generally to machine learning systems for neural networks and natural language processing (NLP) models, and more specifically to a neural network based conversational recommender in an intelligent chatbot application.

### BACKGROUND

E-commerce vendors may often deploy intelligent conversational agents that are trained to recommend products to potential customers, e.g., based on a buyer's item-specific preferences. For the sale of complex items that have multiple attributes, e.g., home stereo systems, musical instruments, furniture, and/or the like, significant expertise of a salesperson and iterative consultation is often involved for a buyer to learn and make an informed purchase decision, instead of a simple recommendation. In particular, for new products and/or products in a completely different category from the user's past purchases, there is little past data to train the recommendation model of the intelligent agent.

### BRIEF DESCRIPTION OF THE DRAWINGS

FIG. 1A is a simplified diagram illustrating a CRS framework built on a Seller bot and a Buyer/Shopper bot, according to some embodiments.

FIG. 1B is a simplified diagram further illustrating aspects of Seller-Shopper simulation shown in FIG. 1A, according to one or more embodiments described herein.

FIG. 2A is a simplified diagram illustrating an example work flow of a Shopper bot generating a response in simulation, according to embodiments described herein.

FIG. 2B is a simplified diagram illustrating a shopper preference generation pipeline, according to embodiments described herein.

FIG. 3 is a simplified diagram illustrating an example work flow of a Seller bot generating a response in simulation shown in FIG. 1B, according to embodiments described herein.

FIG. 4 is a simplified diagram illustrating a computing device implementing the CRS system described in FIGS. 1-3, according to one embodiment described herein.

FIG. 5 is a simplified diagram illustrating a neural network structure underlying the conversational recommendation module in FIG. 4, according to some embodiments.

FIG. 6 is a simplified block diagram of a networked system suitable for implementing the conversational recommendation framework described in FIGS. 1-5 and other embodiments described herein.

FIG. 7 is an example logic flow diagram illustrating a method of a training framework of an artificial intelligence (AI) conversation agent shown in FIGS. 1-6, according to some embodiments described herein.

FIG. 8 shows an example human evaluation user interface for Seller bot, according to embodiments.

FIGS. 9A-9B provide example diagrams illustrating example user interfaces for Seller or Shopper, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

Existing shopping agent bot applications may adopt conversational recommendation systems (CRS) that mostly focus on domains involving content recommendation such as movies, books, music, etc. In such content recommendation domains, CRS systems can achieve success by questioning a user about previous content consumption and retrieving similar content. However, such recommendation strategy may not be valid for CRS systems for the sale of complex items, as prior user habits do not inform a buyer's item-specific preferences. For example, for a user making a first-time purchase on some complex products (e.g., a piano, etc.) which may have multiple attributes (e.g., size, brand, range, finish, type, and/or the like), little prior user interests data may be obtained to make such recommendation. In addition, in real world application, significant expertise and salesmanship is often entailed to conduct an in-depth conversation with a user to make an informed purchase decision. Existing CRS systems that are trained to make a simple product recommendation are incapable of conducting such conversation.

In view of the needs to provide assisted shopping experience for uninformed shoppers, embodiments described herein provide a simulation-based training framework that generates conversational data for training a seller agent model to conduct an assisted conversation with knowledge. Specifically, the framework may employ a neural network model that simulates a shopper, and another neural network model that simulates a buyer. The Shopper model is provided with a product category, based on which Shopper model may generate one or more queries relating to the products in more than one step; and Seller model may receive a buying guide and a product catalog, based on which the Seller model may generate a response. The shopping preference of Shopper model may gradually be generated from the simulated conversation. The simulated conversation may then be used to train Seller model.

In one embodiment, the CRS system may utilize an existing buying guide as a knowledge source for the Seller agent model to generate a response. A relevant guide is provided in addition to a product catalog, which enables them to educate shoppers on the complex product space. In this way, the Shopper agent model may gradually reveal shopping preferences during the course of conversation in order to simulate the underspecified goal scenario of a typical uninformed shopper.

In one embodiment, a multi-dimensional evaluation framework is adopted to evaluate sales agent performance in terms of (a) quality of final recommendation, (b) educational value to the shopper, and (c) fluency and professionalism.

In one embodiment, LLMs may be utilized to build the Seller bot model and/or Shopper bot model which simulate either side in the framework. A wide variety of evaluation and/or simulation between Seller and Shopper may be employed by the framework: human-human, human-bot, bot-human, and bot-bot. In this way, The Seller bot model may be trained by generated dialogue data to conduct a sales recommendation conversation even with unseen complex products having multiple attributes to both educate an uninformed shopper and to recommend purchasing options. The recommendation performance of the Seller bot model is thus improved as former recommendation models were unable to conduct an educational salesforce dialogue with little prior user interests information in the domain. Neural network technology in intelligent bot applications is thus improved.

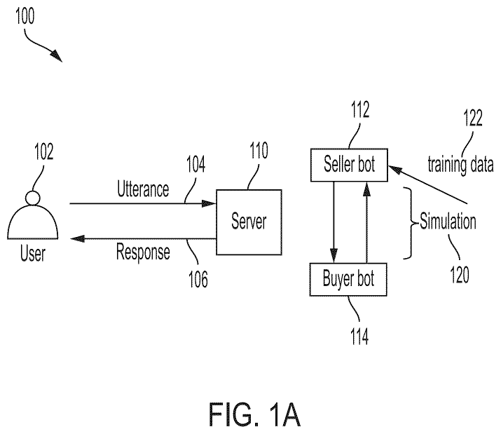

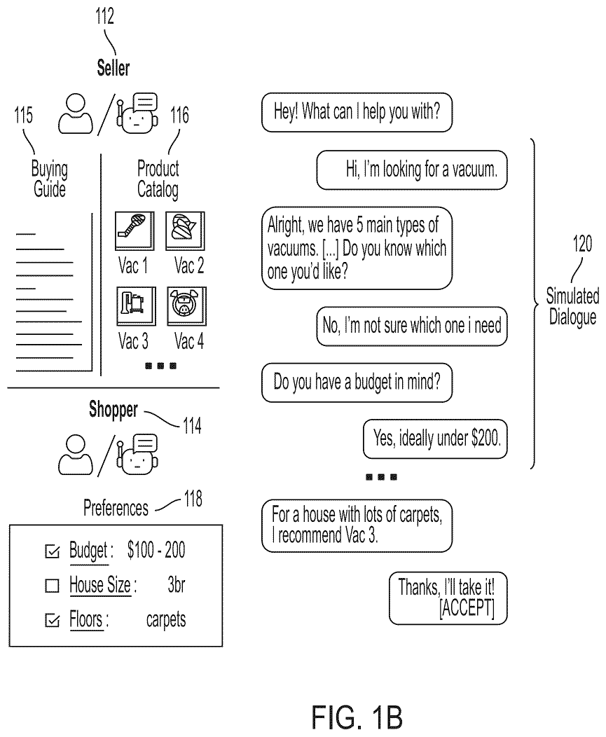

FIG. 1A is a simplified diagram illustrating a CRS framework 100 built on a Seller bot 112 and a Buyer/Shopper bot 114, according to some embodiments. In one embodiment, the CRS framework 100 may comprise a user 102 interacting with a Seller bot 112 hosted on a server 110. For example, the user 102 may generate an utterance 104 indicating questions and/or requests relating to an online shopping experience, and the server hosting Seller bot 112 may generate a response 106 in return.

To train Seller bot 112 to conduct such a CRS conversation with knowledge, a Shopper bot 114 may be employed to co-create a simulation 120 that depicts a seller-shopper interaction. For example, the Seller bot 112 and/or the Shopper bot 114 may be one or more LLMs housed on server 110, or external to server 110 that is accessible via a network.

In one embodiment, the Seller bot 112 and the Shopper bot 114 may have a conversation that begins with a Shopper request and ends once the Seller bot 112 makes a product recommendation that the Shopper bot 114 accepts. The created dialogue through simulation 120 may be used as training data 122 to train the Seller bot 112. The trained Seller bot 112 may then be deployed at server 110 to serve user 102.

FIG. 1B is a simplified diagram further illustrating aspects of Seller-Shopper simulation 120 shown in FIG. 1A, according to one or more embodiments described herein. In one embodiment, each actor, Seller bot 112 or Shopper bot 114, may be either be simulated by an LLM-based system or enacted by a person such as a sales professional or crowd worker. Each agent gets access to specific content elements that assist them in completing the task of conducting a conversation relating to purchasing a complex item. For example, such content elements include a product catalog 116 and a buying guide 115 accessible to the Seller bot 112, and shopping preferences 118 accessible to the Shopper bot 114. Each content element may be populated for a number of product categories, and may be expanded to new products by simply updating the content elements.

In one embodiment, Seller bot 112 may have access of a buying guide 115 and a product catalog 116 as knowledge documents, based on which to generate a response for the simulated dialogue 120.

In one embodiment, the product catalog 116 may comprise a list of products that can be recommended to the Shopper 114. Each product entry comprises (1) a unique ID, (2) a product name, (3) a price, (4) a product description, and (5) a feature set. These synthetic product entries in the product catalog 116 may be generated using an LLM since web-scraping an up-to-date product catalog can lead to limitations in terms of open sourcing. For example, the LLM may be prompted to generate a diverse list of an average of 30 product names for a given category (e.g., TVs). An example prompt for generating product names may take a form similar to the following:

Generate a list of top 30 [PRODUCT_NAME] options in the following format: {“name”: . . . } Include a diverse list of options with different brands, sizes, price points for a variety of customers.

Then the LLM may be prompted each product name to generate realistic product metadata, including a title, description, price, and feature list. An example prompt for generating product metadata may take a form similar to the following:

Generate product description, features, and price based on the product name. Output should be in the following json format:

{
“name”: “...”
“price”: “...”
“description”: “...”
“features”: [...]
}

An example data entry for a product in the product catalog 116 may take a form similar to:
name Samsung 55″ Class S95B OLED 4K Smart Tizen TV
price $1,699.99
description Samsung OLED TV changes the game again with 8.3 million self-lit pixels and ultra powerful 4K AI Neural Processing, all for a picture so real, it's surreal. Add on Dolby Atmos® sound built in, the latest Smart TV apps, and a LaserSlim design and get a viewing experience that's intensely cinematic.
features [“55 inch”, “OLED Technology”, “Neural Quantum Processor with 4K Upscaling”, “Smart Calibration”, “Connectivity with Bluetooth, RF, Wi-Fi, USB, HDMI, Ethernet (LAN), Digital Audio Out x 1 (Optical)”, “Supported internet services: Netflix, Google TV, Amazon Instant Video, YouTube, Browser”]

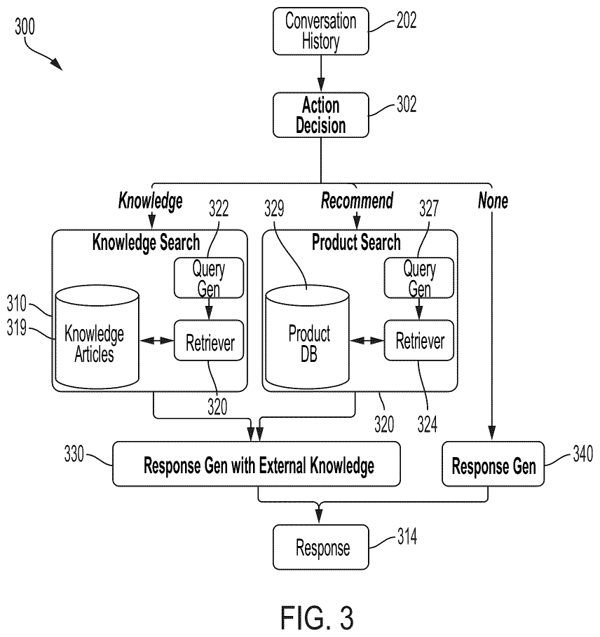

Therefore, during a conversation, the Seller bot 112 may decide on their turn to recommend one or several items whose details will be included in a subsequent message to the Shopper bot 114, or a human shopper. Additional details of Seller bot 112 generating a seller response may be found in relation to FIG. 3.

In one embodiment, buying guide 115 may be another content element that Seller bot 112 bases on to generate a message for Shopper bot 114. For example, in real life, professional salespeople often receive training or rely on technical documentation to effectively sell complex products. This expert knowledge may be obtained through leveraging publicly available buying guides. Buying guides 115, such as ones available on BestBuy2 or Consumer Reports3, are often written by professionals to help coach buyers on the decision-making process so that they can determine the best option for themselves. For each product category in the product catalog 116, the top five articles may be retrieved from the C4 corpus that match the search query “[PRODUCT] Buying Guide”, and the most appropriate one may be selected to incorporate into the buying guide 115. Thus, for example, on average, the buying guide for each product category may comprise 2,500 words and 50 paragraphs long. Selected buying guides are diverse in their organization, with some being organized by shopper persona, shopping budget, or major item subcategories (e.g., drip vs. espresso machines). The heterogeneity in the layout of buying guides goes towards creating a realistic experimental setting in which the layout of knowledge documents for a particular product might not be known in advance.

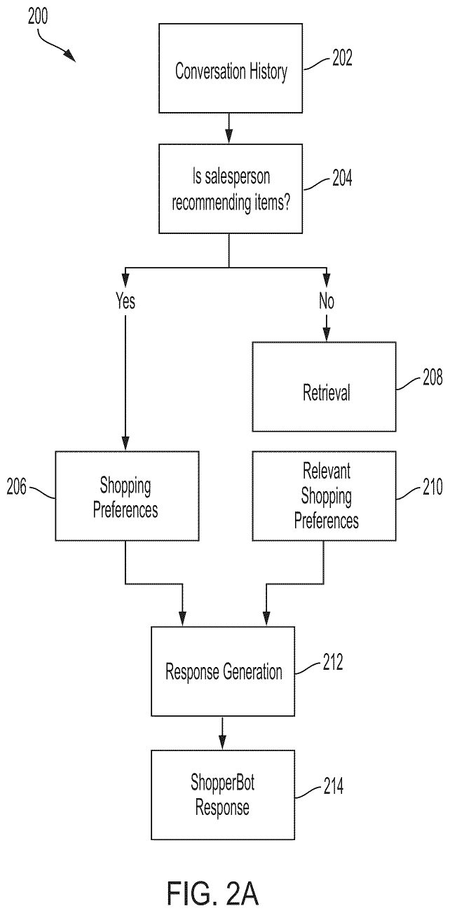

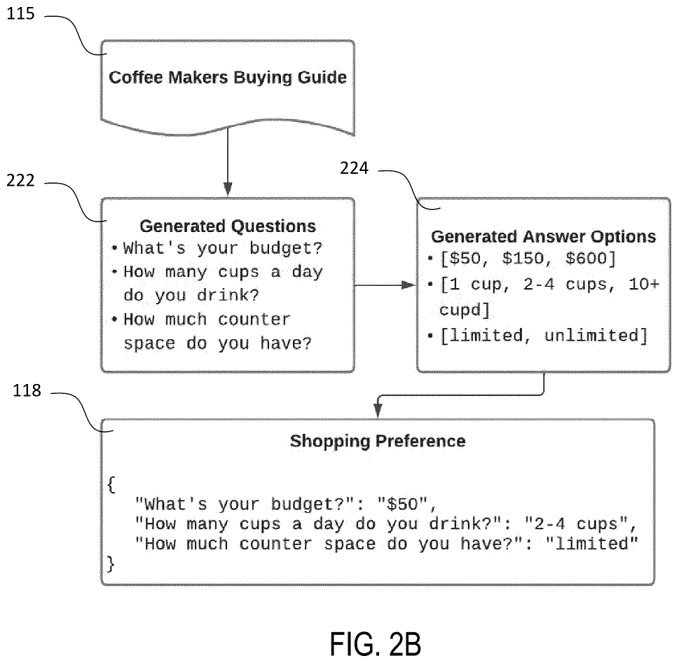

FIG. 2A is a simplified diagram illustrating an example work flow of a Shopper bot 114 generating a response in simulation 120, according to embodiments described herein. In one embodiment, Shopper bot 114 may generate responses in accordance with the provided set of preferences (P), comprising several question-answer pairs (q-a). For example, given the current conversation history 202 between Shopper bot and Seller bot, Shopper bot may determine whether Seller bot is recommending items, e.g., from a last utterance of Seller bot in the conversation history 202. If one or more items are recommended at 204, a list of currently revealed shopping preferences 206 are retrieved. Shopper bot is instructed to include [ACCEPT] or [REJECT] token in its reply. It will base this decision on the whole set of preferences (P) to ensure consistency with the simulated scenario—i.e., if too few preferences were revealed at this point in the conversation, Shopper bot may not accept an item that would not satisfy the whole set P.

If the Seller utterance is not recommending items at 204, a retriever model 208 may be used to retrieve relevant shopping preferences 210 that may be relevant to the conversation history 202. In some situations, the Shopper bot 114 is instructed to make its own decisions when choices are not in P (e.g., the preferred color of a coffee machine) and fluently converse with the Seller.

In one embodiment, response generation module 212 may prompt an LLM acting as Shopper bot 114 with (a) natural language instruction to act as a shopper seeking [PRODUCT] (e.g., a TV), (b) a list of currently revealed shopping preferences 206 or 210, and (c) the chat history 202, at every turn in the conversation, to generate the response 214. For example, an example Shopper prompt for an LLM Shopper may take a similar form to:

You are shopping online for a {product}. You haven't done your research on this product and want to speak to a salesperson over chat to learn more and make an informed decision.
Follow these rules:
Chat with the salesperson to learn more about {product}. They will be acting as a product expert, helping you make an informed purchasing decision. They may ask you questions to narrow down your options and find a suitable product recommendation for you.
Use your assigned preferences and incorporate them in your response when appropriate, but do not reveal them to the salesperson right away or all at once. Only share a maximum of 1 assigned preference with the salesperson at a time.
Let the salesperson drive the conversation.
Ask questions when appropriate. Be curious and try to learn more about {product} before making your decision.
Be realistic and stay consistent in your responses.
When the salesperson makes a recommendation, you'll see product details with ‘ACCEPT’ and ‘REJECT’ in the message. Please consider whether the product satisfies your assigned preferences.
If the recommended product meets your needs, generate [ACCEPT] token in your response. For example, “[ACCEPT] Thanks, I'll take it!”. If the recommended product is not a good fit, let the salesperson know (e.g. “this is too expensive”)
If you're not sure about the recommended product, ask follow-up questions (e.g. “could you explain the benefit of this feature?”) Do not generate more than 1 response at a time.
Your assigned preferences: {preferences}
Follow the above rules to generate a reply using your assigned prefer ences and the conversation history below:
Conversation history:
{chat_history} Shopper:

In one embodiment, shopper bot 114 may gradually learn about shopping preferences 118 through simulated dialogue 120, as simulating the behavior of a human buyer shown in FIG. 1B. For example, FIG. 2B is a simplified diagram illustrating a shopper preference generation pipeline, according to embodiments described herein. As shown in FIG. 2B, first, a list of five possible questions (e.g., 222) that the Seller bot 112 may ask based on the buying guide 115. Second, for each question, a set of answer options 224 (e.g. [“1”, “2-4”, “5-9”, “10+”]) may be generated. Although mutually exclusive questions may be more desirable, it is inevitable for some combinations to be improbable (e.g., a very high-capacity coffee maker for the smallest budget), thus, LLMs may be used in a third step to select multiple diverse but realistic combinations of the preferences 118. In this way, shopping preferences 118 may be revealed to the Shopper bot 114 gradually during the conversation, providing a more realistic simulation of an underspecified buying experience shopping.

To achieve this objective, for each Shopper turn in the conversation, the last Seller message may be extracted, and a semantic similarity model may be used to detect whether the Seller message corresponds to a question related to one of the preferences. If the similarity passes a manually selected threshold, the related preference is revealed to the Shopper, and they can choose to leverage the additional information in their response. In one embodiment, the system may reveal at most one preference per Shopper turn and does not enforce that all preferences are revealed. In this way, a realistic conversational experience for the Shopper and Seller may be simulated.

FIG. 3 is a simplified diagram 300 illustrating an example work flow of a Seller bot 112 generating a response in simulation 120 shown in FIG. 1B, according to embodiments described herein. As shown in FIG. 3, the Seller bot may be implemented through an LLM-powered agent comprising, an action decision module 302, a knowledge search module 310, a product search module 320, and a response generation module 330/340.

The action decision module may decide which module to use based on the current conversation history 202, e.g., from the knowledge search module 310, product search module 320 or response generation module 330. An LLM may be queried to make this choice and provide natural language instructions on when to use each of the available tools in the prompt.

For example, when a knowledge search module 310 is determined, the module 310 may educate a buyer (e.g., a simulated Shopper bot 114 or a human shopper) by incorporating expert domain knowledge into the conversation, which comprises: 1) query generation 322, and 2) retrieval 320 from a knowledge article database 319. Specifically, an LLM may be used to generate a query based on the chat history 202. A FAISS retriever 320 may be used to lookup relevant knowledge article paragraphs. For example, top three paragraphs may be concatenated (separated by “\n\n”) and fed as external knowledge to the Response Generation module 330.

For another example, when a product search module 320 is determined, the module 320 may find relevant items to recommend to the Shopper, which comprises: 1) query generation 327, and 2) retrieval 324. Specifically, each product's information (i.e., title, description, price, and feature list) is embedded with sentence transformer embedding model and top 4 products are retrieved based on the query embedding (obtained using the same model). The retrieved results may thus be concatenated and fed to response generation module 330.

In one embodiment, during a chat, all product search queries may be logged. As a result, the metadata generated may be used in knowledge-grounded response generation, conversational summarization, and query generation.

In one embodiment, the retrieved products may not all be needed, for example, if the shopper asked a follow-up question about a certain product, the response should not include all retrieved items. The Response Generation module 330 may determine which products should be mentioned based on the chat history 202.

In one embodiment, based on the Action Decision, the response generation module (either with external knowledge 330 or without external knowledge 340) may either include external information (e.g., buying guide excerpts, product information) or not. For example, two separate prompts may be written to respond to the shopper. Response Generation with external knowledge at module 330 may be based on chat history 202, action selected, query generated and retrieved results. Response generation 340 without external knowledge may be based on solely on the chat history 202.

In one embodiment, a Regeneration submodule may be implemented to rewrite the final response 314 if needed. For example, a limit on max_tokens generated may be placed when prompting an LLM and ask it to rewrite the previously generated response if it was cut off due to length. This forces the responses 314 to be concise and contain full sentences.

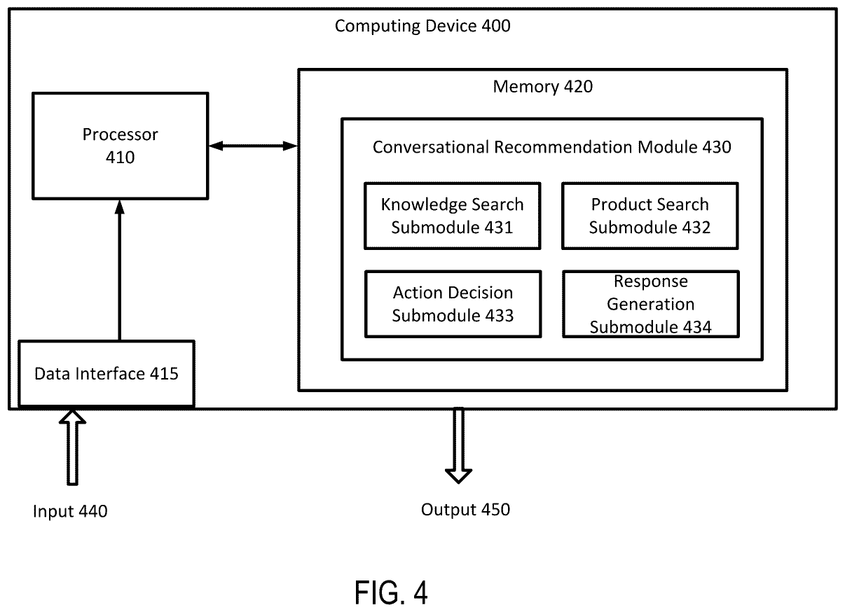

FIG. 4 is a simplified diagram illustrating a computing device implementing the CRS system described in FIGS. 1-3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for CRS module 430 that may be used to implement and/or emulate the systems and models, and/or to implement any of the methods described further herein. CRS module 430 may receive input 440 such as an input training data (e.g., prior dialogues) via the data interface 415 and generate an output 450 which may be a recommended item.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as current dialogues, from a user via the user interface.

In some embodiments, the CRS module 430 is configured to conduct a conversation with a user combining both educational and product recommendation objectives, particularly in the context of complex products and/or flexible user preferences, as described herein. The CRS module 430 may further include knowledge search submodule 431 (e.g., similar to knowledge search in FIG. 3), product search submodule 432 (performing functionality similar to product search in FIG. 3), action decision submodule 433 (e.g., similar to 302 in FIG. 3) and response generation submodule 434 (e.g., similar to 330, 340 in FIG. 3).

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

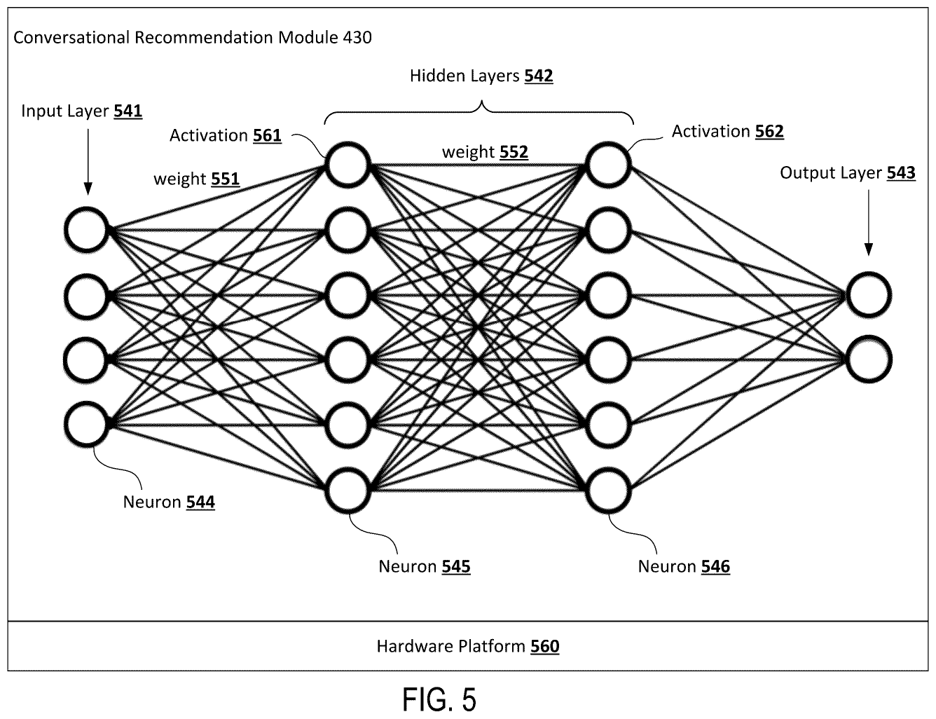

FIG. 5 is a simplified diagram illustrating the neural network structure implementing the CRS module 430 described in FIG. 4, according to some embodiments. In some embodiments, the CRS module 430 and/or one or more of its submodules 431-434 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as an ongoing sales dialogue. The number of nodes (neurons) in the input layer 441 may be determined by the dimensionality of the input data (e.g., the length of a vector of conversational data. Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the CRS module 430 receives an input 440 of a dialogue and transforms the input into an output 450 of a recommended item or a next-step action of the agent response. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the CRS module 430 and/or one or more of its submodules 431-434 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a transformer based LLM, and/or the like.

In one embodiment, the CRS module 430 and its submodules 431 may be implemented by hardware, software and/or a combination thereof. For example, the CRS module 430 and its submodules 431 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based CRS module 430 and one or more of its submodules 431-434 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as prior conversational data are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding response to a user utterance) from the training data, to compute a loss function that measures the discrepancy between the predicted output and the expected output. For example, the loss function may be cross entropy, MMSE, KL-divergence, and/or the like. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as conducting a conversation with a user for recommending a complex item.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in intelligent agent applications in e-Commerce.

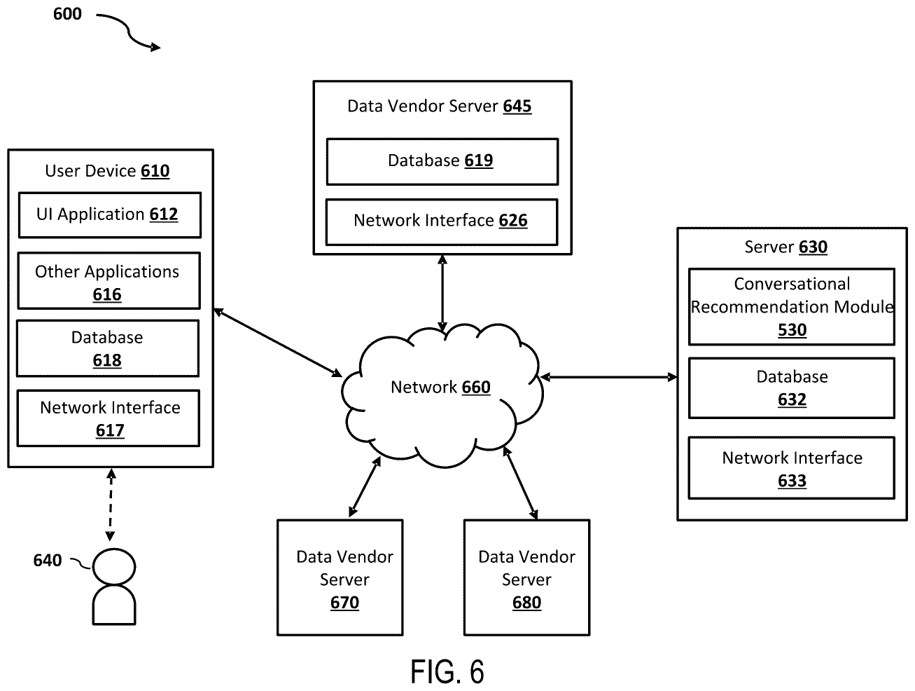

FIG. 6 is a simplified block diagram of a networked system 600 suitable for implementing the CRS framework described in FIGS. 1-3 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLER. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating an agent response from the server 630 and display the message via the UI application 612. In other embodiments, user device 610 may include additional or different modules having specialized hardware and/or software as required.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view an agent response in a dialogue.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

In one embodiment, vendor servers 645, 670, 608 may host one or more LLMs, which may be employed and/or prompted to act as one or more of Shopper bot 118 and Seller bot 112 in one or more simulations 120 as described in FIGS. 1A-3.

Data vendor server 645 may correspond to a server that hosts database 619 to provide training datasets including prior dialogue data to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the CRS module 430 and its submodules described in FIG. 4A. In some implementations, CRS module 430 may receive data from database 619 at the data vendor server 645 via the network 660 to generate an agent response. The generated agent response may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the CRS module 430. In one implementation, the database 632 may store previously generated agent response, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

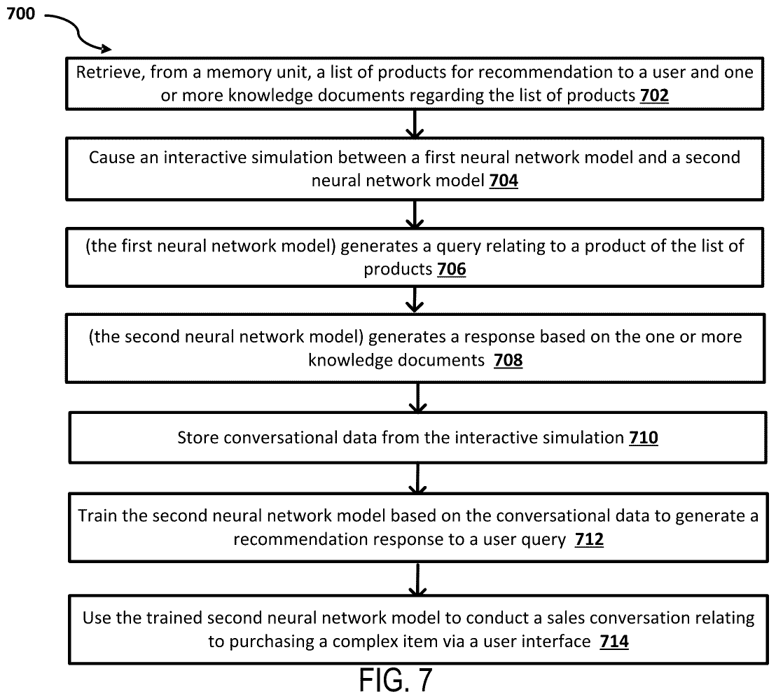

FIG. 7 is an example logic flow diagram illustrating a method of a training framework of an artificial intelligence (AI) conversation agent shown in FIGS. 1-6, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the answer generation network module 530 (e.g., FIGS. 5 and 7).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 702, a list of products for recommendation (e.g., product catalog 116 in FIG. 1B) may be retrieved for a user and one or more knowledge documents (e.g., buying guide 115 in FIG. 1B) regarding the list of products may be retrieved.

At step 704, an interactive simulation (e.g., simulated dialogue 120 in FIG. 1B) may be caused between a first neural network model (e.g., Shopper bot 114) and a second neural network model (e.g., Seller bot 112). For example, the first neural network model is an LLM located on an external server accessible via a communication network.

At step 706, the first neural network model generates a query (e.g., response 214 in FIG. 2A) relating to a product of the list of products. For example, the list of products and a first prompt instructing the first neural network model to generate questions relating to one or more characteristics of the product may be fed as input to the first neural network model.

At step 708, the second neural network model generates a response (e.g., response 314 in FIG. 3) based on the one or more knowledge documents. For example, the query and the one or more knowledge documents together with a second prompt instructing the second neural network to generate answers using at least one knowledge document as context information may be fed as input to the second neural network model. The second neural network comprises a retriever model (e.g., 320 in FIG. 3) that retrieves the at least one knowledge document as relevant to the query. The interactive simulation is caused by iteratively feeding the response as an input to the first neural network model to generate a next query.

At step 710, conversational data from the interactive simulation may be stored.

At step 712, the second neural network model (e.g., Seller bot 112 in FIG. 1B) may be trained based on the conversational data (e.g., 120 in FIG. 1B) to generate a recommendation response to a user query. For example, a first query from the conversational data is fed to the second neural network, which generates a predicted response conditioned on the one or more knowledge documents and the conversational data. A loss may be computed by comparing a first response from the conversational data and the predicted response. The second neural network model is thus updated based on the loss. Additional details of training a neural network can be found in FIG. 5.

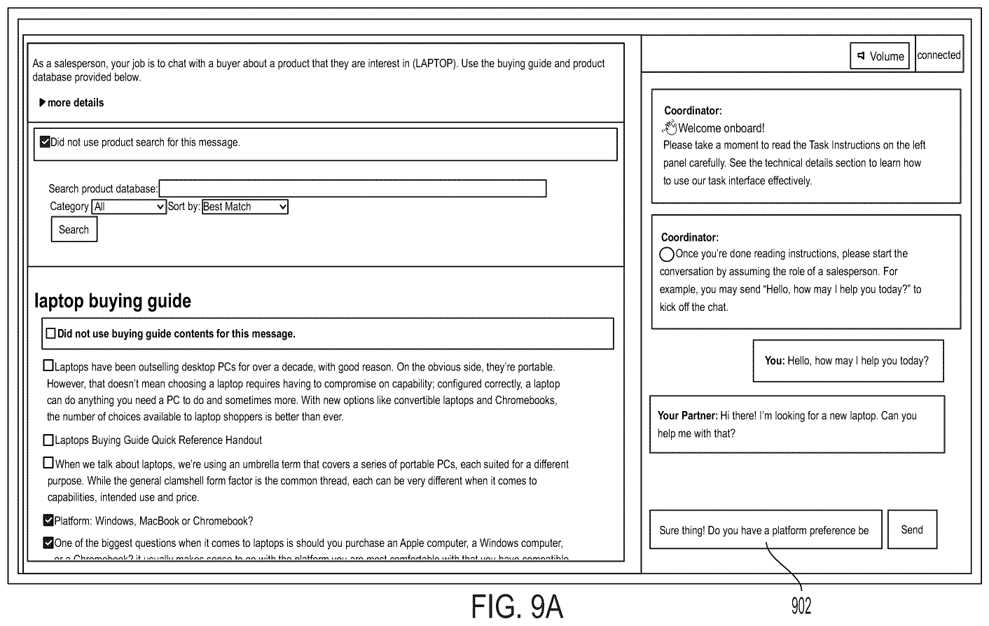

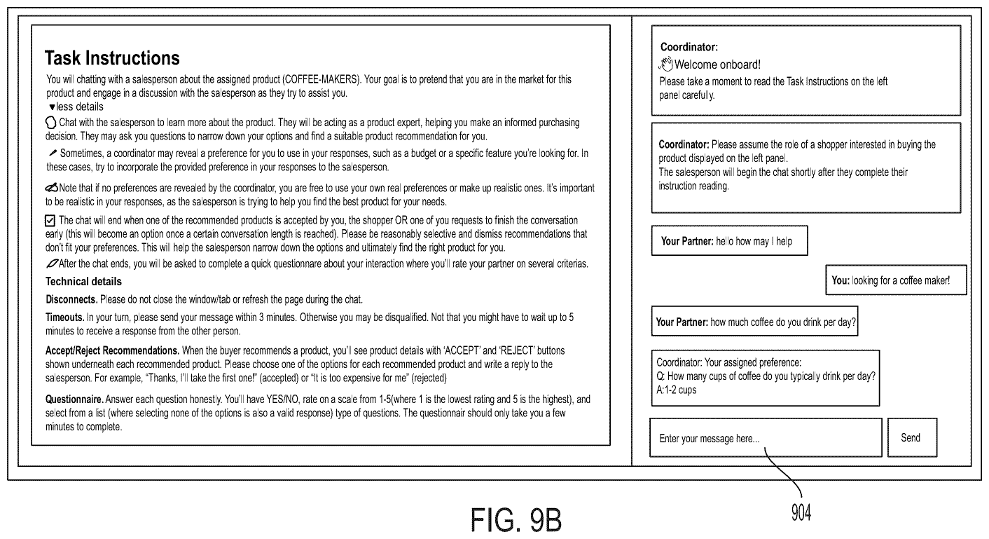

At step 714, the trained second neural network model may be used to conduct a sales conversation relating to purchasing a complex item via a user interface (e.g., see FIG. 9A).

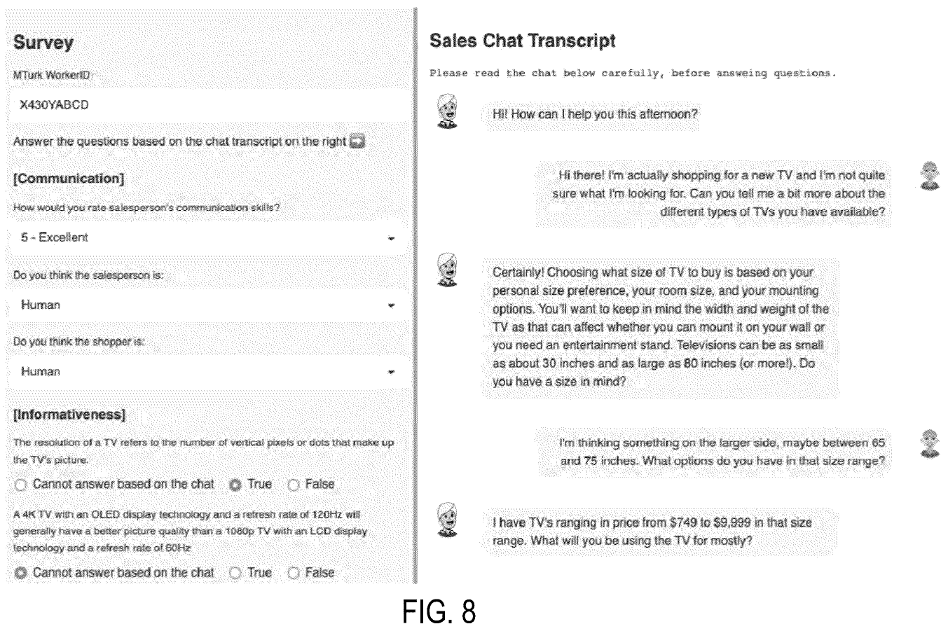

FIG. 8 shows an example human evaluation user interface for Seller bot, according to embodiments. As shown, human evaluators may be asked to select utterances from a chat where Shopper revealed their preferences and rate the conversation partner.

FIGS. 9A-9B provide example diagrams illustrating example user interfaces for Seller or Shopper, according to embodiments described herein. FIG. 9A shows an example seller user interface which may be accessed, engaged, and/or otherwise used by a human salesperson. The interface (1) contains the Buying Guide and a search interface to the Product Catalog, (2) a user may select which paragraphs of the Buying Guide they are leveraging in crafting their response (if any), (3) the post-chat questionnaire (as shown in FIG. 8) which asks to select utterances where Shopper revealed their preferences and rate the conversation partner. For example, the underlying Seller bot may generate a recommended response 902 displayed in the dialogue generation box for the user to select, edit and/or send to the current conversation with a shopper.

In one embodiment, during a chat, all product search queries may be logged. As a result, the metadata generated may be used in knowledge-grounded response generation, conversational summarization, and query generation.

FIG. 9B shows an example shopper user interface which may be accessed, engaged, and/or otherwise used by a human shopper at inference. The shopper is only provided with the product category they are tasked with shopping for at the initial stage of a chat. Shopping preferences are revealed based on the Seller's questioning as the conversation unfolds. The Shopper interface comprises one-sided “Coordinator” messages to reveal Shopping Preferences during the conversation, and when a product recommendation is suggested by the Seller, the Shopper interface displays buttons to accept or reject the item.

The seller-shopper framework described in FIGS. 1-9B may be evaluated by a multi-dimensional evaluation that defines success for the Seller along three axes: (1) recommendation quality, which verifies whether the recommendations of the Seller are compatible with the Shopper's preferences, (2) informativeness, which checks whether the Seller provides educational value to the Shopper, and (3) fluency which evaluates the Seller's ability to communicate professionally and concisely.

In one embodiment, accurate recommendations that match shopper preferences are a core expectation of CRS. On average, a given shoppingpreference configurationyielded 4 acceptable products from a product catalog of 30 items. Thus, for a completed SalesOps conversation, we compute recommendation accuracy (Rec).

In one embodiment, two metrics may be used to measure the informativeness of the Seller during a conversation. First, an NLI-based model is used to measure the content overlap between the Seller's utterances and the buying guide, as such model has been shown to perform competitively on tasks involving factual similarity. Specifically, the % of the buying guide sentences that are entailed at least once by a seller utterance (Infe) is calculated. Second, the shopper's knowledge through a quiz designed which consists of 3 multiple-choice questions that can be answered using the buying guide.

In one embodiment, example questions are framed to measure the fluency and professionalism of the Seller:

Flue: How would you rate the salesperson's communication skills? (scale: 1-5)

Flui: Do you think the seller in the given chat is: (i) human or (ii) a bot? (Yes/No)

Annotation may be performed for the two fluency metrics both manually by recruiting crowd-workers as well as by prompting GPT-4 to answer both questions.

In one embodiment, Table 1 presents statistics and evaluation results of the comparison between professional Salespeople and Seller bot. Overall, Seller bot'ss utterances are almost twice as long. It makes its first recommendation earlier and makes slightly more recommendations in total than professional salespeople. Looking at the human evaluation, crowd workers were largely able to distinguish between SalesBot and professionals, as they were much more likely to believe the Seller was human for professionals (80%) than for SalesBot (55%), yet SalesBot achieved a higher Likert fluency score. This is likely due to salespeople acting more casual in conversations, making occasional typos which come across as less professional.

TABLE 1

| Statistics (avg) | [symbol] | [symbol] |
|---|---|---|
| Nb. words of Seller utterance | 62.5 | 35.3 |
| Nb. words of Shopper utterance | 20.8 | 20.7 |
| Nb. of turns | 11.9 | 12.9 |
| Nb. turns before the first rec. | 6.0 | 7.9 |
| Nb. of recommendations | 2.6 | 2.4 |
| Nb. of triggered revelations | 1.7 | 2.8 |
| % Correct recommendations (Rec) | 44 | 54 |
| Information Quiz Score (Inf_{q}) | 32.9 | 31.8 |
| Fluency Score (Fluₑ) | 4.4 | 4.2 |
| % Is Human (Fluᵢ) | 55 | 80 |

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for a training framework of an artificial intelligence (AI) conversation agent, comprising:
retrieving, from a memory unit, a list of products for recommendation to a user and one or more knowledge documents regarding the list of products;
causing an interactive simulation between a first neural network model and a second neural network model, wherein the first neural network model generates a query relating to a product of the list of products, and the second neural network model generates a response based on the one or more knowledge documents;
storing conversational data from the interactive simulation; and
training the second neural network model based on the conversational data to generate a recommendation response to a user query.

2. The method of claim 1, wherein the first neural network model is located on an external server accessible via a communication network.

3. The method of claim 1, wherein the interactive simulation is caused by:
feeding the list of products and a first prompt instructing the first neural network to generate questions relating to one or more characteristics of the product as input to the first neural network model

4. The method of claim 3, wherein the interactive simulation is caused by:
feeding the query and the one or more knowledge documents together with a second prompt instructing the second neural network to generate answers using at least one knowledge document as context information as input to the second neural network model.

5. The method of claim 4, wherein the second neural network comprises a retriever model that retrieves the at least one knowledge document as relevant to the query.

6. The method of claim 1, wherein the interactive simulation is caused by iteratively feeding the response as an input to the first neural network model to generate a next query.

7. The method of claim 1, wherein the training the second neural network model based on the conversational data comprises:
feeding a first query from the conversational data to the second neural network;
generating, by the second neural network, a predicted response conditioned on the one or more knowledge documents and the conversational data;
computing a loss by computing a first response from the conversational data and the predicted response; and
updating the second neural network model based on the loss.

8. A system for a training framework of an artificial intelligence (AI) conversation agent, the system comprising:
a memory storing a list of products for recommendation to a user and one or more knowledge documents regarding the list of products, and a plurality of processor-executable instructions; and
one or more processors executing the instructions to perform operations comprising:
causing an interactive simulation between a first neural network model and a second neural network model, wherein the first neural network model generates a query relating to a product of the list of products, and the second neural network model generates a response based on the one or more knowledge documents;
storing, at the memory, conversational data from the interactive simulation; and
training the second neural network model based on the conversational data to generate a recommendation response to a user query.

9. The system of claim 8, wherein the first neural network model is located on an external server accessible via a communication network.

10. The system of claim 8, wherein the interactive simulation is caused by:
feeding the list of products and a first prompt instructing the first neural network to generate questions relating to one or more characteristics of the product as input to the first neural network model

11. The system of claim 10, wherein the interactive simulation is caused by:
feeding the query and the one or more knowledge documents together with a second prompt instructing the second neural network to generate answers using at least one knowledge document as context information as input to the second neural network model.

12. The system of claim 11, wherein the second neural network comprises a retriever model that retrieves the at least one knowledge document as relevant to the query.

13. The system of claim 8, wherein the interactive simulation is caused by iteratively feeding the response as an input to the first neural network model to generate a next query.

14. The system of claim 8, wherein the operation of training the second neural network model based on the conversational data comprises:
feeding a first query from the conversational data to the second neural network;
generating, by the second neural network, a predicted response conditioned on the one or more knowledge documents and the conversational data;
computing a loss by computing a first response from the conversational data and the predicted response; and
updating the second neural network model based on the loss.

15. A non-transitory processor-readable storage medium storing a plurality of processor-executable instructions for a training framework of an artificial intelligence (AI) conversation agent, the processor-executable instructions executed by one or more processors to perform operations comprising:
retrieving, from a memory unit, a list of products for recommendation to a user and one or more knowledge documents regarding the list of products;
causing an interactive simulation between a first neural network model and a second neural network model, wherein the first neural network model generates a query relating to a product of the list of products, and the second neural network model generates a response based on the one or more knowledge documents;
storing conversational data from the interactive simulation; and
training the second neural network model based on the conversational data to generate a recommendation response to a user query.

16. The medium of claim 15, wherein the first neural network model is located on an external server accessible via a communication network.

17. The medium of claim 15, wherein the interactive simulation is caused by:
feeding the list of products and a first prompt instructing the first neural network to generate questions relating to one or more characteristics of the product as input to the first neural network model

18. The medium of claim 17, wherein the interactive simulation is caused by:
feeding the query and the one or more knowledge documents together with a second prompt instructing the second neural network to generate answers using at least one knowledge document as context information as input to the second neural network model.

19. The medium of claim 18, wherein the second neural network comprises a retriever model that retrieves the at least one knowledge document as relevant to the query.

20. The medium of claim 15, wherein the interactive simulation is caused by iteratively feeding the response as an input to the first neural network model to generate a next query.
